(19) United States
(12) Patent Application Publication
(10) Pub. No.: US 2007/0152001 A1
(43) Pub. Date: Jul. 5, 2007

(54) CROSSBAR LOCKING DEVICE

(75) Inventors: Hyun-Young CHO, Chungcheongnam-do (KR); Hee-Deog KIM, Seoul (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/533,974

(22) Filed: Sep. 21, 2006

(30) Foreign Application Priority Data
Jan. 3, 2006 (KR) 10-2006-0000596

(51) Int. Cl. B60R 9/00

(52) U.S. Cl. 224/315; 224/319; 224/325

(57) ABSTRACT

Disclosed herein is a crossbar locking device for removably locking the opposite ends of a crossbar to respective roof racks. The crossbar locking device of the present invention includes operating modules, which are provided on the respective opposite ends of the crossbar, and a cable, which couples the operating modules to each other such that the operating modules are operated in conjunction with each other. Therefore, the present invention has an advantage in that, when one operating module is operated, the two operating modules are simultaneously locked to or unlocked from the respective roof racks. Furthermore, because the present invention has a structure such that locking pins are locked to respective roof racks, there is an advantage in that reliable locking force is ensured.

This application claims the benefit of the filing date of Korean Patent Application No. 10-2006-0000596, filed on Jan. 3, 2006, in the Korean intellectual Property Office, the disclosure of which is incorporated herein its entirety by reference

### BACKGROUND OF THE INVENTION

1. Field of the Invention

The present invention relates generally to locking devices for locking crossbars to roof racks and, more particularly, to a crossbar locking device, which includes operating modules provided on respective opposite ends of a crossbar, and a cable that couples the operating modules to each other such that the operating modules are operated in conjunction with each other, so that the opposite ends of the crossbar can be locked to or unlocked from the roof racks at the same time.

2. Description of the Related Art

As well known to those skilled in the art, roof carriers are apparatuses which are installed on roofs of vehicles for loading thereon various loads, particularly, relatively large loads compared to the width of the vehicles and relatively long loads, such as ski equipment. Hereinafter, a representative conventional roof carrier will be explained with reference to FIG. 1. As shown in FIG. 1, a roof carrier includes a pair of roof racks 10, which are longitudinally provided on the roof of a vehicle, a pair of crossbars 20, which are coupled to the roof racks, and a plurality of locking devices 30, which fasten the crossbars 20 to the roof racks 10.

Each crossbar 20 is mounted to the roof racks 10 in a direction crossing the roof racks 10. Furthermore, the locking devices 30 are provided on respective opposite ends of each crossbar 20. The crossbar 20 is selectively fastened to the roof racks 10 at a desired position by the locking devices 30.

In the conventional roof carrier having the above-mentioned construction, the locking devices 30, which are provided on the respective opposite ends of the crossbar 20, are constructed such that they are independently operated during a process of locking or unlocking the cross bar 20 to the roof racks 10. Therefore, to adjust the position of the crossbar 20 depending on the size of the load received on the roof carrier, two persons must simultaneously manipulate the two locking devices 30 provided on the respective opposite ends of the crossbar 20. Of course, one user may consecutively manipulate the locking devices 30 to unlock the crossbar 20 from the roof racks 10. However, in this case, a problem in that the user must manipulate the locking devices 30 still remains.

In an effort to overcome these problems, a locking device having the following construction, which improves on the conventional locking device 30, was proposed in Korean Patent Laid-open Publication No. 2005-0035591.

In this locking device, as shown in FIG. 2, when a user rotates a cam 25 at one side of a vehicle, two compression rods 21 are simultaneously moved inwards so that frictional pads 22 come into close contact with respective roof racks 10. Thus, the crossbar is fastened to the roof racks by the frictional force between the frictional pads 22 and the roof racks 10.

However, this locking device is also problematic in that, because it supports a load only using frictional force between the frictional pads 22 and the roof racks 10, the force that locks the crossbar to the roof racks 10 is insufficient.

### SUMMARY OF THE INVENTION

Accordingly, the present invention has been made keeping in mind the above problems occurring in the prior art, and an object of the present invention is to provide a crossbar locking device, in which the opposite ends of a crossbar can be locked to or unlocked from roof racks at the same time by manipulating one of operating modules, which are provided on respective opposite ends of the crossbar and operate a cable using rotation of a turn lever, and which has a structure such that a locking pin is inserted into each roof rack, so that the crossbar can be reliably locked to the roof racks.

In order to accomplish the above object, the present invention provides a crossbar locking device including: operating modules provided on respective opposite ends of the crossbar; and a cable coupling the operating modules to each other such that the operating modules are operated in conjunction with each other. Each of the operating modules includes: a base mounted to an end of the crossbar; a turn lever rotatably mounted to the base and having a cable holding part, to which an end of the cable is coupled, a manipulating part to allow a user to manipulate the turn lever, and a connection part coupling the cable holding part to the manipulating part, the turn lever operating the cable when the turn lever is rotated with respect to the base; and a locking unit, having a locking pin inserted into or removed from the related roof rack depending on operation of the cable by rotation of the turn lever, a pulley receiving part provided on an end of the locking pin, with a pulley rotatably provided in the pulley receiving part, and a connection shaft provided through the pulley receiving part and fastened to the base.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a roof rack and a crossbar;

FIG. 2 is a schematic sectional view showing a conventional crossbar locking device;

FIG. 3 is a perspective view of a crossbar locking device, according to an embodiment of the present invention;

FIG. 4 is a perspective view of an enlargement of a turn lever of the crossbar locking device according to the present invention;

FIG. 5 is a perspective view showing a separate hand lever mounted to the crossbar locking device according to the present invention;

FIGS. 6a and 6b are sectional views showing an operational mechanism of the crossbar locking device according to the present invention; and

FIG. 7 is a plan view showing a housing of the crossbar locking device according to the present invention.

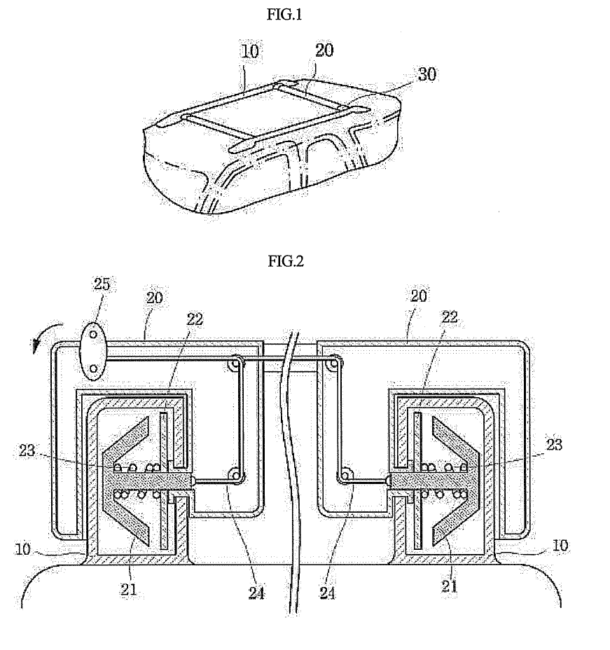

### DESCRIPTION OF THE PREFERRED EMBODIMENTS

Hereinafter, a preferred embodiment of the present invention will be described in detail with reference to the attached drawings.

The present invention relates to a crossbar locking device, which includes operating modules, which are mounted to respective opposite ends of a crossbar, and a cable, which couples the operating modules to each other such that the operating modules are operated in conjunction with each other, so that the opposite ends of the crossbar are fastened to or removed from respective roof racks by manipulating the cable using turn levers provided in the operating modules.

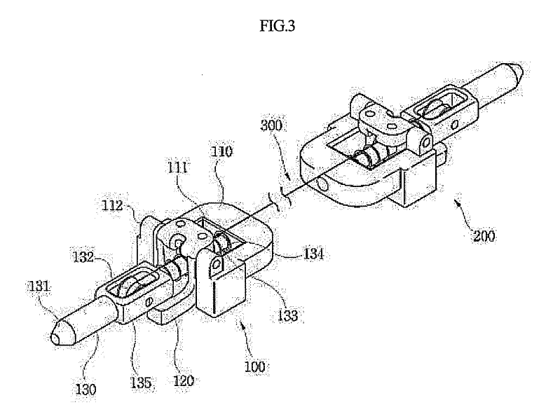

The present invention will be explained in detail herein below with reference to FIG. 3. As shown in FIG. 3, the present invention includes operating modules 100 and 200, which are mounted to respective opposite ends of a crossbar C, and a cable 300, which couples the operating modules 100 and 200 to each other such that the operating modules 100 and 200 are operated in conjunction with each other.

The operating modules 100 and 200 have the same construction, therefore only one operating module 100 will be explained. The operating module 100 includes a base 110, which is mounted to an end of the crossbar C, a turn lever 120, which is mounted to the base 110 and operates the cable 300, and a locking unit 130, which is inserted into or removed from a roof rack R by manipulating the cable 300 using the turn lever 120.

The base 110 is mounted to the crossbar C and is provided with hinge parts 112 on the upper surface thereof so that the turn lever 120, which will be explained in detail later herein, is coupled to the hinge parts 112 of the base 110 using a pin. Furthermore, the base 110 has a receiving part 111 therein, and a connection shaft 133 of the locking unit 130 which will be explained in detail later herein is mounted to the receiving part 111 of the base 110.

The locking unit 130 includes a locking pin 131, which is inserted into and fastened to the roof rack R, a pulley receiving part 135, which extends from an end of the locking pin 131, and in which a pulley 132 is rotatably provided, and the connection shaft 133, which is coupled through the pulley receiving part 135 and is coupled to the receiving part 111 of the base 110.

In the crossbar locking device having the above-mentioned construction, the locking pin 131 is moved forwards or backwards by the operation of the cable 300 wound around the pulley 132, thereby the locking pin 131 is locked to or unlocked from the roof rack R. Furthermore, a spring 134 is fitted over the connection shaft 133, so that the locking pin 131 is biased towards the roof rack R by the restoring force of the spring 134 such that it is inserted into the roof rack R and maintains the state of being fastened to the roof rack R. This operational mechanism will be described in detail later herein.

As described above, the locking unit 130 is advanced forwards or retracted backwards by the cable 300. The cable 300 is operated by the turn level 120.

As shown in FIG. 4, the turn lever 120 includes a cable holding part 123, to which the cable 300 is coupled, a manipulating part 121, which a user grips and manipulates, and a connection part 122, which couples the cable holding part 123 and the manipulating part 121 to each other. Furthermore, a through hole 124 is formed at a predetermined position in the turn lever 120, so that the turn lever 120 is rotatably coupled to the hinge parts 112 of the base 110 through the through hole 124 using a pin. Thus, when the turn lever 120 is rotated, the cable 300 is operated. As well, a slot 125 is formed through the turn lever 120, and the connection shaft 133 of the locking unit 130 is coupled to the receiving part 111 of the base 110 through the slot 125.

In detail, when the user raises the manipulating part 121 of the turn lever 120 upwards, the manipulating part 121 is rotated around the through hole 124, through which the turn lever 120 is coupled to the hinge parts 112 of the base 110 using the pin. Thereby, the cable holding part 123 is also rotated around the through hole 124. Due to this operation, the cable holding part 123 pulls the cable 300, so that the locking pin 131 of the locking unit 130, which has been inserted in the roof rack R, is moved backwards, thus being unlocked from the roof rack R. At this time, the pulley 132, which is provided in the locking unit 130, is rotated by the movement of the cable 300. Thanks to this rotation of the pulley 132, the force required to pull the locking pin 131 is reduced. Meanwhile, a locking hole 123a may be formed in the cable holding part 123 for ease of a process of coupling the cable 300 to the cable holding part 123.

Furthermore, because the locking pin 131, which has been moved backwards, is advanced and inserted into the roof rack R by the restoring force of the spring 134 fitted over the connection shaft 133, the locking device automatically enters and maintains the locked state. Therefore, the present invention has an advantage in that it is returned to the locked state even without a user deliberately manipulating the operating module.

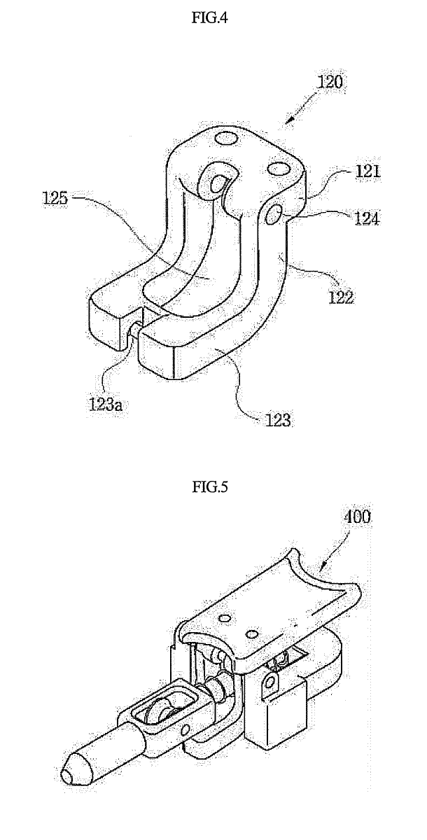

Meanwhile, as shown in FIG. 5, a hand lever 400, which is larger than that of the manipulating part 121 of the turn lever 120, may be provided on the manipulating part 121 in order to reduce the force required for operating the manipulating part 121.

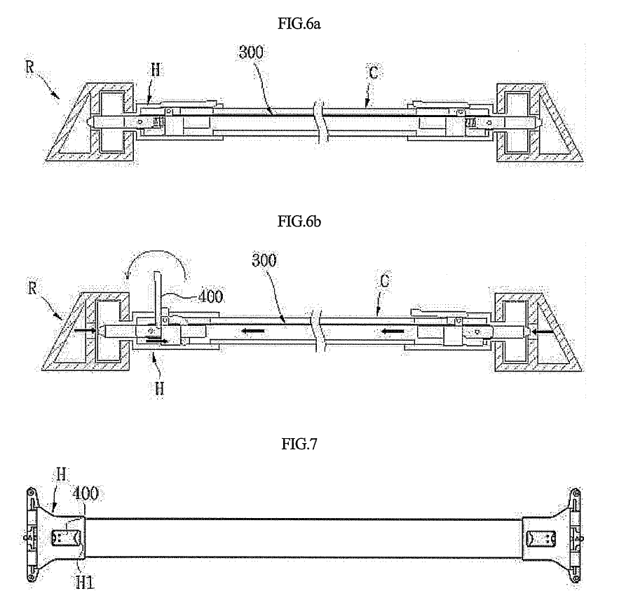

On the assumption that the operating modules of the present invention are provided on the opposite ends of the crossbar C, a mechanism for simultaneously locking or unlocking the opposite ends of the crossbar C to or from respective roof racks will be explained with reference to FIGS. 6a and 6b.

FIG. 6a is a sectional view showing a state in which the operating modules, which are provided on the opposite ends of the crossbar C, are locked to the respective roof racks R. FIG. 6b is a sectional view showing the locking device which is in an unlocked state in which the operating modules are removed from the roof racks.

As shown in FIG. 6a, each operating module of the present invention is mounted in the crossbar C. Here, the operating module may be mounted to the crossbar C by fastening the base 110 of the operating module to the crossbar C using a bolt.

The operating module is received in a housing H. The housing H will be explained later herein.

As stated above, FIG. 6a illustrates the state in which the operating modules, which are provided on the opposite ends of the crossbar C, are locked to the respective roof racks R. Hereinafter, the operational mechanism of the two operating modules will be explained on the basis of the left operating module 100. Of course, the operational mechanism of the right operating module 200 is the same as that of the left operating module 100.

First, when the user rotates the hand lever 400 upwards, the manipulating part 121 of the turn lever 120, which is fastened to the hand lever 400, is rotated upwards along with the hand lever 400. Then, the turn lever 120 is rotated in a counterclockwise direction around the through hole 124, through which the turn lever 120 is coupled to the hinge parts 112 of the base 110 by the pin. Thereby, the cable holding part 123 of the turn lever 120 is rotated in a counterclockwise direction around the through hole 124, so that the cable 300, which is held by the cable holding part 123, is pulled to the right.

At this time, the cable 300, which is pulled to the right, is moved around the pulley 132 of the locking unit 130, so that the locking pin 131 of the locking unit 130 is also pulled to the right. Here, the present invention may be constructed such that the connection shaft 133 is inserted into the base 110. Alternatively, it may be constructed such that the connection shaft 133 passes through the pulley receiving part 135.

As such, when the locking pin 131, which has been inserted into and locked to the roof rack R, is retracted backwards, the crossbar C, which has been in the locked state, is released.

Meanwhile, by being pulled through the pulley 132, part of the cable 300 which is coupled to the operating module 200 provided on the right end of the crossbar C is moved to the left. Due to this, the locking pin of the right operating module 200 is also removed and released from the associated roof rack R.

As such, the opposite operating modules are simultaneously operated by manipulation of only one operating module. Therefore, the crossbar C can be released from the roof racks R through only a single process. Furthermore, because the present invention has a structure such that the locking pins 131 are inserted into and locked to the respective roof racks R, the force locking the crossbar C to the roof racks R is reliably ensured.

As well, when the user releases the hand lever 400 after he/she has unlocked the crossbar C from the roof racks R by rotating the hand lever 400 upwards, the locking pin 131 is automatically biased in a locking direction by the restoring force of the spring 134 provided on the connection shaft 133.

Therefore, for example, when it is desirable to put a load having a predetermined size on the roof of a vehicle, the user unlocks the crossbar C by manipulating the operating module and moves the crossbar C to a position corresponding to the size of the load. Then, the crossbar C is automatically returned to the locked state by the restoring force of the spring 134, thus being more convenient for the user, and enhancing the stability of the crossbar C mounted to the roof racks R.

Meanwhile, in the present invention, the housing H may be provided on each end of the crossbar C to cover the operating module and because contact between the housing H and the related roof rack R makes it easy to move the crossbar C. Furthermore, thanks to installation of the housing H, which covers each operating module mounted to the crossbar C and has an opening, through which the hand lever 400 coupled to the turn lever 120 is exposed outside, a good appearance is ensured.

As described above, in the conventional art, there is a problem in that two persons must simultaneously manipulate locking devices, which are provided on opposite ends of a crossbar, in order to lock the crossbar to roof racks. To solve this problem, a locking device having a structure, in which, when a user rotates a cam of the locking device at one side of a vehicle, two compression rods are simultaneously moved inwards and frictional pads thus come into close contact with the respective roof racks so that the crossbar is fastened to the roof racks by the frictional force between the frictional pads and the roof racks, was proposed. However, this locking device is also problematic in that, because the crossbar is locked to the roof racks using only frictional force between the frictional pads and the roof racks, the locking force is insufficient.

On the other hand, in the present invention, operating modules are provided on respective opposite ends of a crossbar, and the operating modules are operated in conjunction with each other using a cable. Therefore, the present invention has an advantage in which, when one operating module is operated, the two operating modules are simultaneously locked to or unlocked from the respective roof racks.

Furthermore, because the present invention has a structure such that locking pins are locked to respective roof racks, there is an advantage in that reliable locking force is ensured.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A crossbar locking device for locking a crossbar to a pair of roof racks, comprising:
operating modules provided on respective opposite ends of the crossbar; and a cable coupling the operating modules to each other such that the operating modules are operated in conjunction with each other, wherein each of the operating modules comprises:
a base mounted to an end of the crossbar;
a turn lever rotatably mounted to the base, the turn lever comprising: a cable holding part, to which an end of the cable is coupled; a manipulating part to allow a user to manipulate the turn lever; and a connection part coupling the cable holding part to the manipulating part, the turn lever operating the cable when the turn lever is rotated with respect to the base; and
a locking unit, comprising: a locking pin inserted into or removed from the related roof rack depending on operation of the cable by rotation of the turn lever; a pulley receiving part provided on an end of the locking pin, with a pulley rotatably provided in the pulley receiving part; and a connection shaft provided through the pulley receiving part and fastened to the base.

2. The crossbar locking device as set forth in claim 1, further comprising:
a hand lever having a size larger than a size of the manipulating part of the turn lever and mounted on the manipulating part.

3. The crossbar locking device as set forth in claim 1, further comprising:
a spring provided on the connection shaft between the locking pin and the base to maintain the locking pin in a state of insertion into the roof rack.

4. The crossbar locking device as set forth in claim 1, further comprising:
a housing provided on each of the opposite ends of the cross bar and receiving each of the operating modules therein, with an opening formed through an upper surface of the housing so that the manipulating part of the turn lever is exposed through the opening.

5. The crossbar locking device as set forth in claim 1, wherein a through hole is formed at an upper position in the turn lever and a hinge part is provided on an upper surface of the base so that the turn lever is rotatably coupled to the hinge part of the base through the through hole of the turn lever using a pin, and the connection shaft of the locking unit is coupled to the receiving part of the base through a slot formed through the turn lever.

6. The crossbar locking device as set forth in claim 2, wherein a through hole is formed at an upper position in the turn lever and a hinge part is provided on an upper surface of the base so that the turn lever is rotatably coupled to the hinge part of the base through the through hole of the turn lever using a pin, and the connection shaft of the locking unit is coupled to the receiving part of the base through a slot formed through the turn lever.

7. The crossbar locking device as set forth in claim 3, wherein a through hole is formed at an upper position in the turn lever and a hinge part is provided on an upper surface of the base so that the turn lever is rotatably coupled to the hinge part of the base through the through hole of the turn lever using a pin, and the connection shaft of the locking unit is coupled to the receiving part of the base through a slot formed through the turn lever.

8. The crossbar locking device as set forth in claim 4, wherein a through hole is formed at an upper position in the turn lever and a hinge part is provided on an upper surface of the base so that the turn lever is rotatably coupled to the hinge part of the base through the through hole of the turn lever using a pin, and the connection shaft of the locking unit is coupled to the receiving part of the base through a slot formed through the turn lever.
